(19) United States
(12) Patent Application Publication
(10) Pub. No.: US 2003/0048902 A1
(43) Pub. Date: Mar. 13, 2003

(54) Method and apparatus for scrambling and descrambling the ATM cell payloads

(76) Inventor: Shih-Chi Wu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/153,797

(22) Filed: May 24, 2002

(30) Foreign Application Priority Data
Sep. 13, 2001 (TW) 90122723

(51) Int. Cl. H04K 1/00

(52) U.S. Cl. 380/261

(57) ABSTRACT

A method for scrambling and descrambling a data bitstream of an ATM cell using a computer device in which a recursion number and a bit number are stored. The method comprises the steps of sequentially storing a plurality of bits of an initial and a data bitstream, wherein the number of the bits of the initial bitstream is equal to the recursion number, carrying out a logic operation in parallel of a first and second group of the successively stored bits to derive a third group of resulting bits, wherein the numbers of the bits in each of the three groups are equal to the bit number, and the first bits in the first and second group are the first bits of the initial and data bitstream respectively.

### BACKGROUND OF THE INVENTION

1. Field of the Invention

The present invention relates to a scrambler and descrambler, particularly to an apparatus and method for scrambling and descrambling the ATM cell payloads.

2. Description of the Prior Art

In the implementation of an ADSL (Asymmetric Digital Subscriber Loop) modem, there is one scrambler/descrambler for ATM TC (Asynchronous Transfer Mode Transmission Convergence) layer. It is defined in ITU-T I.432. Data to be transferred by ADSL is segmented into ATM cells, each of which has 53 bytes wherein 5 bytes are grouped into a Header and the other 48 bytes are grouped into a Payload. The scrambler/descrambler for the ATM TC layer receives the data bitstream and scrambles/descrambles the Payloads of the ATM cells.

FIG. 1 is a circuit diagram showing a conventional serial scrambler for the ATM TC layer. The scrambler 1 carries out the polynomial Xˆ 43+1 defined in the ATM standards and comprises an XOR gate 11 and registers 12₁˜12₄₃ connected in series. Bits of the data bitstream of the ATM cell payloads are sequentially input to the gate 11 through a terminal A and recursively XOR with the previous results. A scrambled data bitstream is output from the terminal B of the gate 11. The descrambler 2 shown in FIG. 2 associated with the scrambler 1 has a similar circuitry wherein the terminal A receives the scrambled data bitstream and the terminal B outputs the recovered or descrambled data bitstream.

Since a serial scrambler/descrambler only scrambles/descrambles the ATM cell payload bit by bit, various parallel scrambler/descramblers have been invented to improve the scrambling/descrambling speed, such as the scramblers/descramblers disclosed in U.S. Pat. Nos. 5,185,799, 5,241,602 and 5,267,316, all of which process more than one bit at one time.

The previously described scramblers/descramblers are implemented and designed for ASIC. When implementing scrambler/descrambler in software, the above architectures may not fit for the architecture of ALU in CPU.

### SUMMARY OF THE INVENTION

Therefore, the object of the present invention is to provide an apparatus and method for scrambling and descrambling the ATM cell payload, which is suitable for software implementation.

The present invention provides a method for scrambling and descrambling the ATM cell payload using a computer device in which a recursion number and a bit number are stored. The method comprises the steps of sequentially storing a plurality of bits of an initial bitstream and the data bitstream, wherein the number of the bits of the initial bitstream is equal to the recursion number, carrying out a logic operation in parallel of a first and second groups of the stored bits in succession to derive a third group of resulting bits, wherein the numbers of the bits in the three groups are equal to the bit number, and the first bits in the first and second group are the first bits of the initial and data bitstream respectively.

The present invention further provides an apparatus for scrambling and descrambling the ATM cell payload. The apparatus comprises a means for storing a recursion number and a bit number, and a means for sequentially storing a plurality of bits of an initial and the data bitstream, wherein the number of the bits of the initial bitstream is equal to the recursion number, a means for carrying out a logic operation in parallel of a first with a second group of the stored bits in succession, to derive a third group of resulting bits, wherein the numbers of the bits in the three groups are equal to the bit number, and the first bits in the first and second group are the first bits of the initial and data bitstream respectively.

In the scrambler/descrambler of the invention, the bits of the data bitstream are sequentially stored in a memory and processed by a processor, such as a CPU. According to the bit numbers of the processor and the data format to be scrambled/descrambled, the processor will process more than one bit at one time. It will improve the operation speed of scrambler/descrambler very much.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a circuit diagram showing a conventional serial scrambler for the ATM TC layer.

FIG. 2 is a circuit diagram showing a conventional serial descrambler for the ATM TC layer.

FIG. 3 is a block diagram showing a scrambler/descrambler according to one embodiment of the invention.

FIGS. 4A˜4C are diagrams showing a method for scrambling the ATM cell payloads according to one embodiment of the invention.

FIGS. 5A˜5C are diagrams showing a method for descrambling the ATM cell payloads according to one embodiment of the invention.

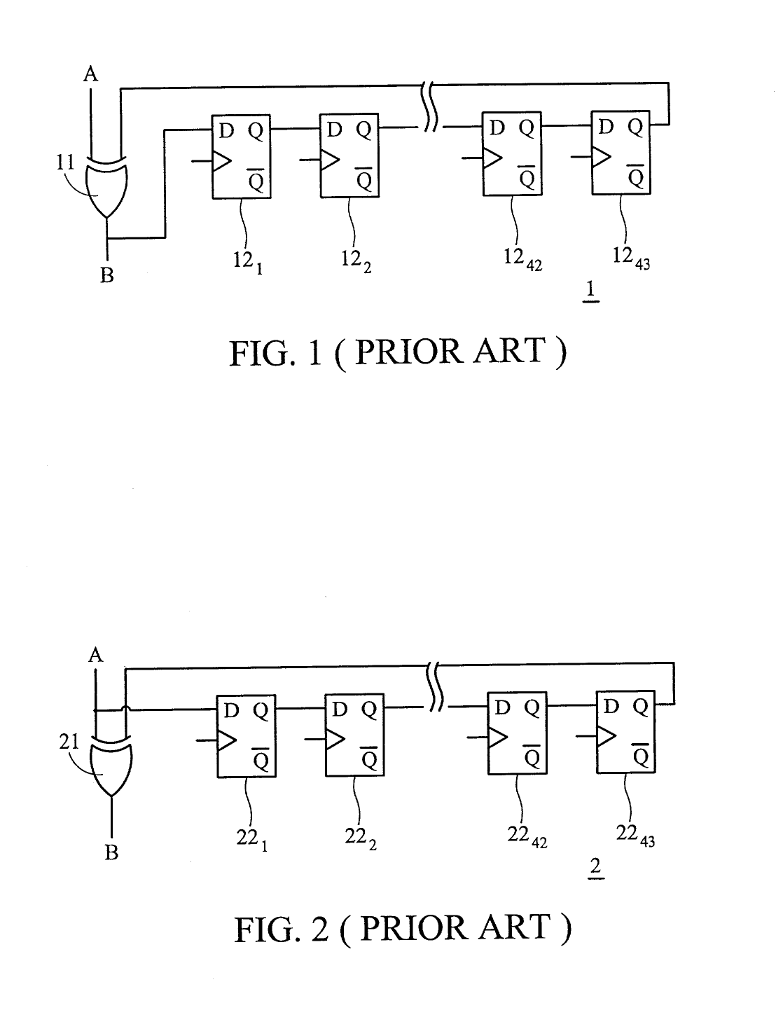

### DETAILED DESCRIPTION OF THE INVENTION

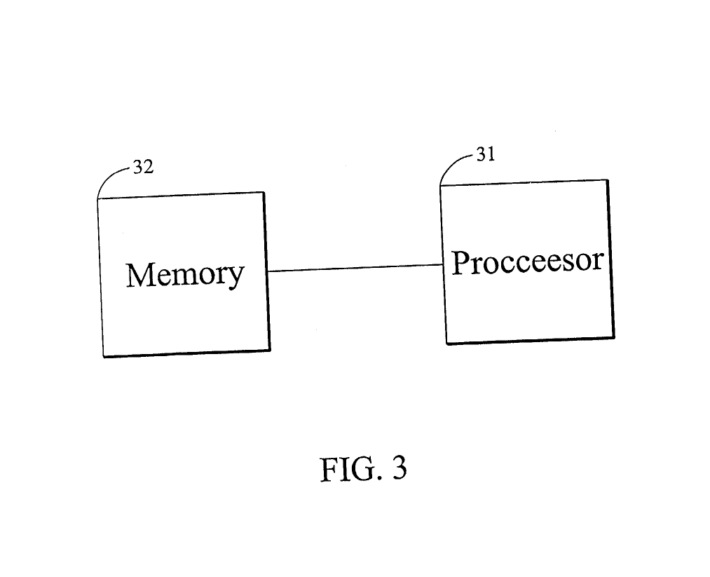

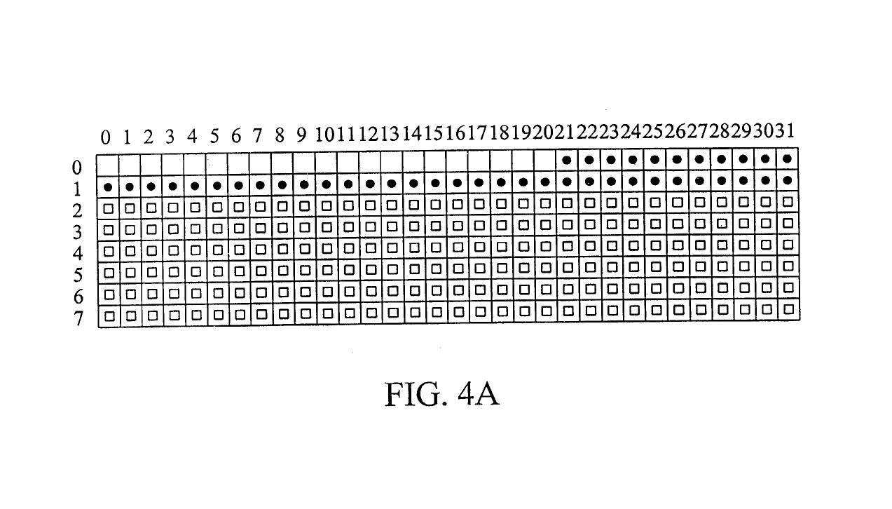

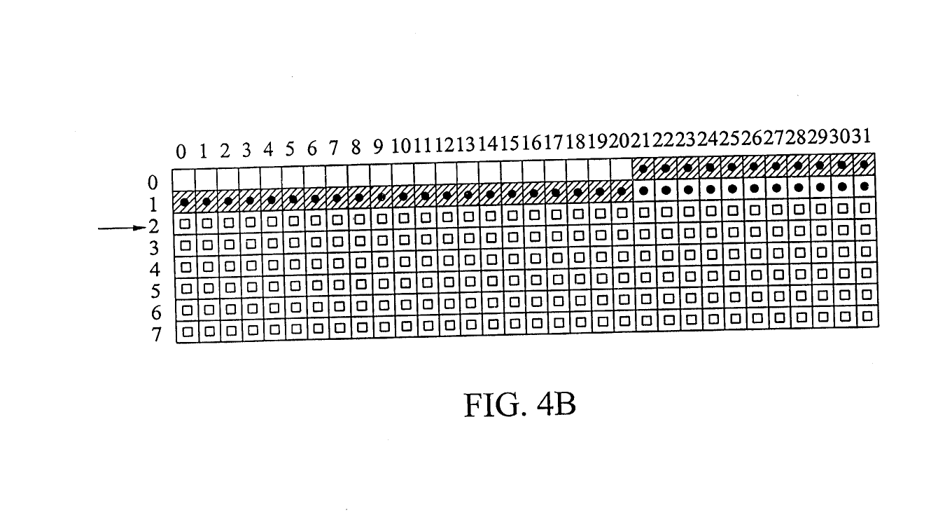

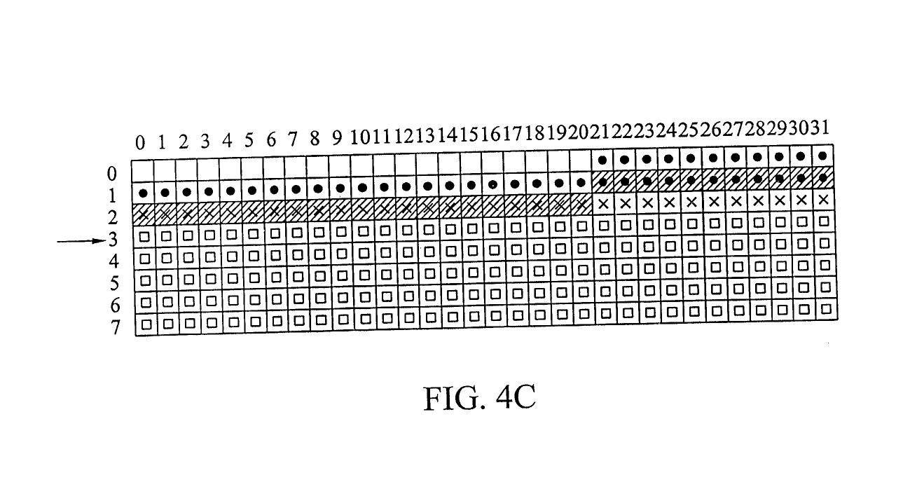

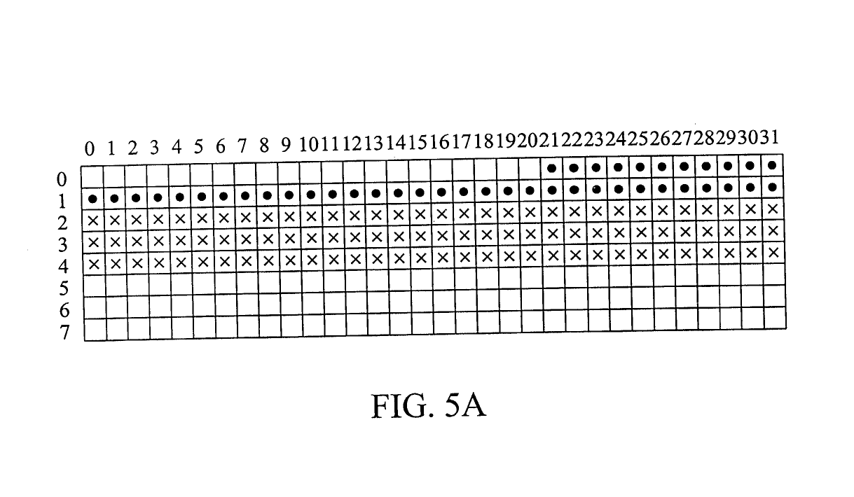

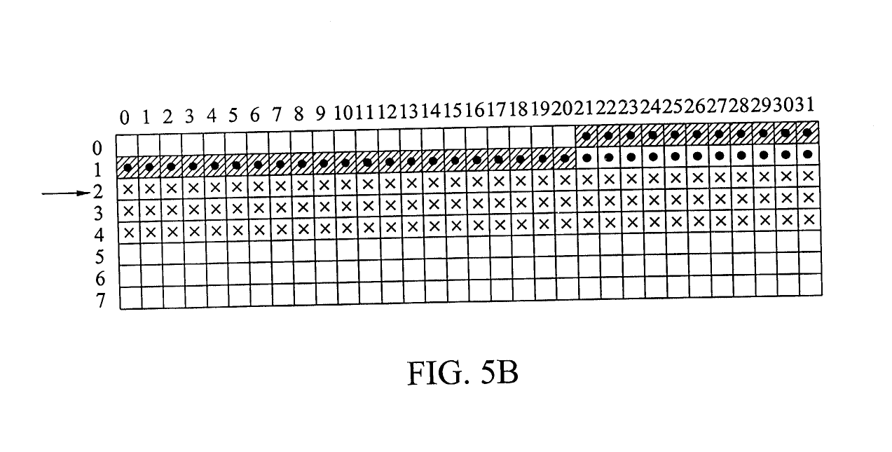

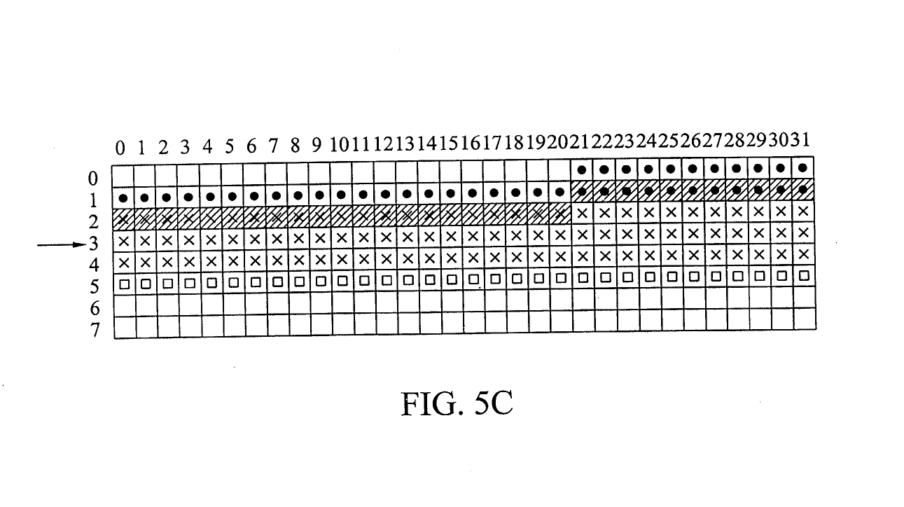

FIG. 3 is a block diagram showing a scrambler/descrambler according to one embodiment of the invention. The scrambler/descrambler comprises a processor 31 and a memory 32. The memory 32 stores data in a memory array. The processor is a 32-bit CPU which can process 32 bits data at one time. The scrambling operation for the ATM TC layer using the scrambler in FIG. 3 is explained with cooperation of FIGS. 4A˜4C in the following. And the descrambling operation for the ATM TC layer using the descrambler in FIG. 3 is explained with cooperation of FIGS. 5A˜5C in the following.

For the scrambling operation; first, please refer to FIG. 4A, in which the memory 32 has a 8×32 memory array. Bits I(0)˜I(42) (represented by “•” in FIG. 4A) of an initial bitstream I are pre-stored in the memory 32 and have sequential addresses

(0,21), (0,22), . . . , (1,0), (1,1), . . . , (1,31),respectively. Then, Bits D(0)˜D(191) (represented by “□” in FIG. 4A) of a data bitstream of the ATM cell unscrambled payloads are received and stored in the memory 32 and have sequential addresses (2,0), . . . ,(7,31),respectively. The number of bits in the initial bitstream is equal to the recursion number 43 in the polynomial Xˆ 43+1 defined by the standards.

Second, please refer to FIG. 4B, in which the processor 31 reads a first group of the 32 bits I(0)˜I(31), i.e. the processor 31 reads a first group of the 32 bits stored in succession in the memory 32 having addresses (0,21)˜(1,20). The processor 31 also reads a second group of the 32 bits D(0)˜D(31), i.e. the processor reads a second group of the 32 bits stored in succession in the memory 32 having addresses (2,0)˜(2,31). Then, the processor 31 carries out the bit to bit XOR operation for the two groups read from the memory 32 to derive a third group of scrambled bits D′(0)˜D′(31) (represented by “×” in FIG. 4C) and substitutes the bits D(0)˜D(31) in the second group with the bits D′(0)˜D′(31) in the third group.

Third, please refer to FIG. 4C, in which the processor 31 continues to read a next group of 32 bits having addresses (1,21)˜(2,20) for the first group and the other next group of the 32 bits D(32)˜D(63) having addresses (3,0)˜(3,31) for the second group. Then, the processor 31 carries out the bit to bit XOR operation for the two groups to derive the scrambled bits D′(32)˜D′(63) for the third group and substitutes the bits D(32)˜D(63) in the second group with the bits D′(32)˜D′(63) in the third group.

Finally, the third step is repeated until all the bits of the ATM cell payloads stored in the memory 32 are scrambled.

For the descrambling operation; first, please refer to FIG. 5A, in which the memory 32 has a 8×32 memory array. Bits I(0)˜I(42) (represented by “•” in FIG. 5A) of an initial bitstream I are pre-stored in the memory 32 and have sequential addresses

(0,21),(0,22), . . . , (1,0),(1,1), . . . , (1,31),respectively. Then, Bits D′(0)˜D′(95) (represented by “×” in FIG. 5A) of a data bitstream of the ATM cell scrambled payloads are received and stored in the memory 32 and have sequential addresses (2,0), . . . , (4,31),respectively. The number of bits in the initial bitstream is equal to the recursion number 43 in the polynomial Xˆ 43+1 defined by the standards.

Second, please refer to FIG. 5B, in which the processor 31 reads a first group of the 32 bits I(0)˜I(31), i.e. the processor 31 reads a first group of the 32 bits stored in succession in the memory 32 having addresses (0,21)˜(1,20). The processor 31 also reads a second group of the 32 bits D′(0)˜D′(31), i.e. the processor reads a second group of the 32 bits stored in succession in the memory 32 having addresses (2,0)˜(2,31). Then, the processor 31 carries out the bit to bit XOR operation for the two groups read from the memory 32 to derive a third group of descrambled bits D(0)˜D(31) (represented by “□” in FIG. 5C) which are stored in memory addresses (5,0)˜(5,31).

Third, please refer to FIG. 5C, in which the processor 31 continues to read a next group of 32 bits having addresses (1,21)˜(2,20) for the first group and the other next group of the 32 bits D(32)˜D(63) having addresses (3,0)˜(3,31) for the second group. Then, the processor 31 carries out the bit to bit XOR operation for the two groups to derive the descrambled bits D(32)˜D(63) for the third group.

Finally, the third step is repeated until all the bits of the ATM cell payloads stored in the memory 32 are descrambled.

In conclusion, in the present invention, the bits of the data bitstream are sequentially stored in a memory and processed by a processor. Scrambling/descrambling of the ATM cell can be carried out in parallel in software, whereby the scrambling/descrambling speed is improved.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for scrambling and descrambling the data bitstream of the ATM cell payload using a computer device in which a recursion number and a bit number are stored, the method comprising the steps of:
sequentially storing a plurality of bits of an initial and a data bitstream, wherein the number of the bits of the initial bitstream is equal to the recursion number;
carrying out a logic operation in parallel of a first and second group of the stored bits in succession to derive a third group of resulting bits, wherein the numbers of the bits in the three groups are equal to the bit number, and the first bits in the first and second group are the first bits of the initial and data bitstream respectively.

2. The method as claimed in claim 1 wherein the data bitstream is a bitstream of a Payload of the ATM cell.

3. The method as claimed in claim 1 wherein the bit number is 32.

4. The method as claimed in claim 1 wherein the recursion number is 43.

5. The method as claimed in claim 1 wherein the logic operation is exclusive-OR.

6. An apparatus for scrambling and descrambling the data bitstream of the ATM cell payload comprising:
a means for storing a recursion number and a bit number;
a means for sequentially storing a plurality of bits of an initial and a data bitstream, wherein the number of the bits in the initial bitstream is equal to the recursion number;
a means for carrying out a logic operation in parallel of a first and second group of the stored bits in succession to derive a third group of resulting bits, wherein the numbers of the bits in the three groups are equal to the bit number, and the first bits in the first and second group are the first bits of the initial and data bitstream respectively;

7. The apparatus as claimed in claim 6 wherein the data bitstream is a bitstream of a Payload of the ATM cell.

8. The apparatus as claimed in claim 6 wherein the bit number is 32.

9. The apparatus as claimed in claim 6 wherein the recursion number is 43.

10. The apparatus as claimed in claim 6 wherein the logic operation is exclusive-OR.
